(19) United States
(12) Patent Application Publication
(10) Pub. No.: US 2024/0223908 A1
(43) Pub. Date: Jul. 4, 2024

(54) EXPOSURE ADJUSTMENT DURING VIEW CHANGING

(71) Applicant: Polycom Communications Technology (Beijing) Co., Ltd., Beijing (CN)

(72) Inventors: Xi LU, Beijing (CN); Hai XU, Beijing (CN); Yongkang FAN, Beijing (CN); Hailin SONG, Beijing (CN); Xingyue HUANG, Beijing (CN); Wenxue HE, Beijing (CN)

(73) Assignee: Polycom Communications Technology (Beijing) Co., Ltd., Beijing (CN)

(21) Appl. No.: 17/909,726

(22) PCT Filed: May 20, 2020
(86) PCT No.: PCT/CN2020/091213

§ 371 Date: Sep. 6, 2022

(51) Int. Cl. H04N 23/73; H04N 7/14; H04N 23/611; H04N 23/69; H04N 23/695

(52) U.S. Cl. CPC H04N 23/73; H04N 7/147; H04N 23/611; H04N 23/69; H04N 23/695

(57) ABSTRACT

A method may include identifying a target view of a video stream, obtaining a target exposure value for the target view, after obtaining the target exposure value, initiating a transition to the target view with the target exposure value from an initial view having an initial exposure value, and transitioning the video stream to the target view using the target exposure value.

### BACKGROUND

Cameras for video conference endpoints use auto exposure (AE) to adjust the exposure value used to generate video frames from image data captured with an image sensor of the camera. Incorrect exposure values yield low quality video that may be either too bright or not bright enough depending on lighting conditions. Different views from a camera may use different exposure values to generate high quality video based on the lighting conditions for the different views. In order to provide the corrected exposure value, video frames in a view are displayed. After displaying the video frames for view, the AE detects exposure of the video frame and then immediately adjusts the exposure for the next frame in the view.

### SUMMARY

In general, in one aspect, one or more embodiments relate to a method including identifying a target view of a video stream, obtaining a target exposure value for the target view, after obtaining the target exposure value, initiating a transition to the target view with the target exposure value from an initial view having an initial exposure value, and transitioning the video stream to the target view using the target exposure value.

In general, in one aspect, one or more embodiments relate to a system including an application processor, a memory, and an image processor, the memory including an application that executes on the application processor, uses the memory, and is configured for: identifying a target view of a video stream, obtaining, by the application processor from the image processor, a target exposure value for the target view, after obtaining the target exposure value, initiating a transition to the target view with the target exposure value from an initial view having an initial exposure value, and transitioning the video stream to the target view using the target exposure value.

In general, in one aspect, one or more embodiments relate to a set of non-transitory computer readable mediums including computer readable program code for: identifying a target view of a video stream, obtaining a target exposure value for the target view, after obtaining the target exposure value, initiating a transition to the target view with the target exposure value from an initial view having an initial exposure value, and transitioning the video stream to the target view using the target exposure value.

Other aspects of the disclosure will be apparent from the following description and the appended claims.

### BRIEF DESCRIPTION OF DRAWINGS

FIG. 1A and FIG. 1B show diagrams of systems in accordance with disclosed embodiments.

FIG. 2 shows a flowchart in accordance with disclosed embodiments.

FIG. 3A, FIG. 3B, and FIG. 3C show examples of user interfaces in accordance with disclosed embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Video conferencing endpoints may use multiple views for different scenes. A view is a portion of the video that is to be displayed. In other words, while the image sensor may capture an image of a larger physical area, the view is the cropped section of the area that is ultimately displayed. Example views include a room view, a group view, a speaker view, and a conversation view. A room view may capture an entire room that is being imaged by a camera of an endpoint without zooming into a particular portion of the raw image from the image sensor. A speaker view zooms into the face of a speaker in the image, which may be identified by applying facial recognition algorithms to the image data from the camera and by applying sound location algorithms to the audio from a microphone array. A group view zooms into a group of people in a room, which may be identified by applying facial recognition algorithms. A conversation view may combine separate views of two (or more) speaker views into a single view (e.g., the video frame of a conversation view may include one rectangle that is the video frame of a first speaker view and a second rectangle that is the video frame of a second speaker view).

Use of the different views provide a more immersive video conference experience. Two methods of view change include a direct cut (change to the target view directly) and an indirect cut (also referred to as a smooth transition) that gradually pans, tilts, and zooms to a target view. When the difference between the exposure value of an initial view and a target view is large, the camera exposure value may change dramatically between different views.

To ensure that the camera uses an exposure value that corresponds to the target view (instead of corresponding to the initial view), the endpoint calculates the exposure value of the target view before transitioning to the target view. After pre-calculating the exposure value for the target view, the camera is instructed to use the pre-calculated target exposure value when changing to the target view. Thus, to the user, the switch in exposure value is more seamless than switching after switching to a target view.

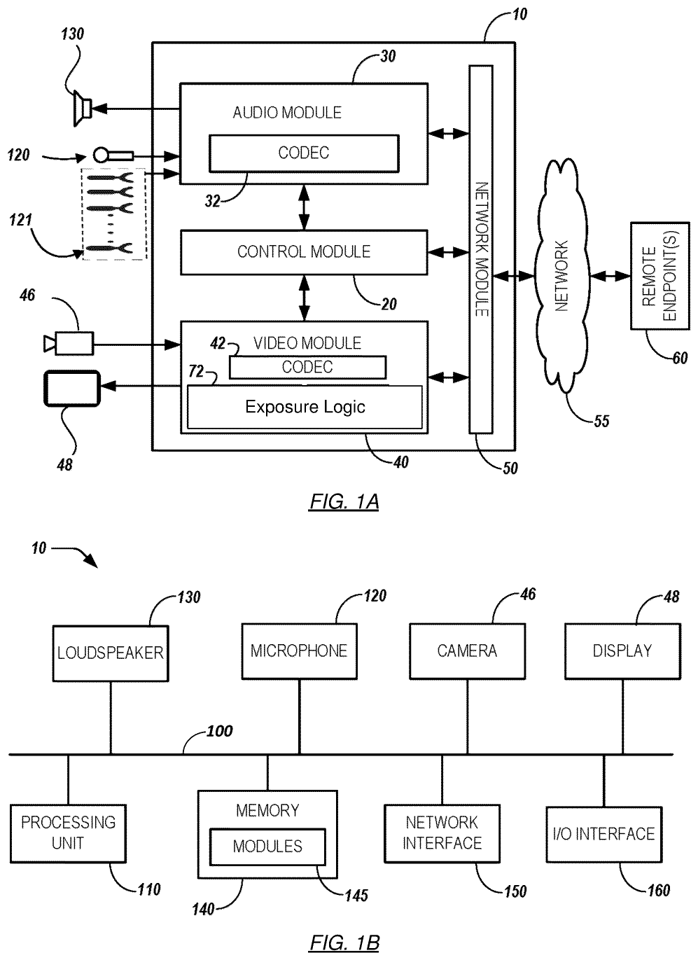

FIG. 1A illustrates a possible operational environment for example circuits of this disclosure. Specifically, FIG. 1A illustrates a conferencing apparatus or endpoint (10) in accordance with an embodiment of this disclosure. The conferencing apparatus or endpoint (10) of FIG. 1A communicates with one or more remote endpoints (60) over a network (55). The endpoint (10) includes an audio module (30) with an audio codec (32), and a video module (40) with a video codec (42). These modules (30, 40) operatively couple to the control module (20) and the network module (50). The modules (30, 40, 20, 50) include dedicated hardware, software executed by one or more processors, or a combination thereof. In some examples, the video module (40) corresponds to a graphics processing unit (GPU), software executable by the graphics processing unit, a central processing unit (CPU), software executable by the CPU, an image processor (also referred to as an image signal processor (ISP)) that processes raw image data from the camera (46), an application processor that executes applications and other programs of the modules, etc. In some examples, the control module (20) includes a CPU or application processor, executable software, or a combination thereof. In some examples, the network module (50) includes one or more network interface devices, a CPU, software executable by the CPU, or a combination thereof. In some examples, the audio module (30) includes, a CPU, software executable by the CPU, a sound card, or a combination thereof. In some examples, the camera (46) includes an image processor, image processing software, or a combination thereof. The different processors, programs, and applications running on the endpoint (10) may communicate with each other using application programming interfaces (APIs) exposed by the processors, programs, and applications.

Auto exposure may be performed with the image processor based on the current view of a video frame to determine the exposure value for a subsequent video frame. Auto exposure may determine an exposure value after transitioning from one view to the next so that the video frames during and after a transition to a new view may have incorrect exposure values with low image quality (too bright, too dark, etc.). The incorrect exposure values may be for the last video frame view prior to transitioning to the target view but may not be correct for the video frames during and after transitioning to the target view.

In general, the endpoint (10) can be a conferencing device, a videoconferencing device, a personal computer with audio or video conferencing abilities, a smartphone, or any similar type of communication device. The endpoint (10) is configured to generate near-end audio and video and to receive far-end audio and video from the remote endpoints (60). The endpoint (10) is configured to transmit the near-end audio and video to the remote endpoints (60) and to initiate local presentation of the far-end audio and video.

The microphone (120) captures audio and provides the audio to the audio module (30) and codec (32) for processing. The microphone (120) can be a table or ceiling microphone, a part of a microphone pod, an integral microphone to the endpoint, or the like. Additional microphones (121) can also be provided. Throughout this disclosure all descriptions relating to the microphone (120) apply to any additional microphones (121), unless otherwise indicated. The endpoint (10) may use the audio captured with the microphone (120) for the near-end audio.

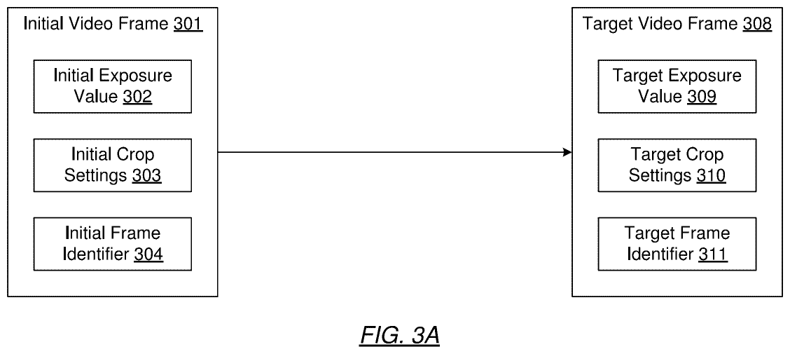

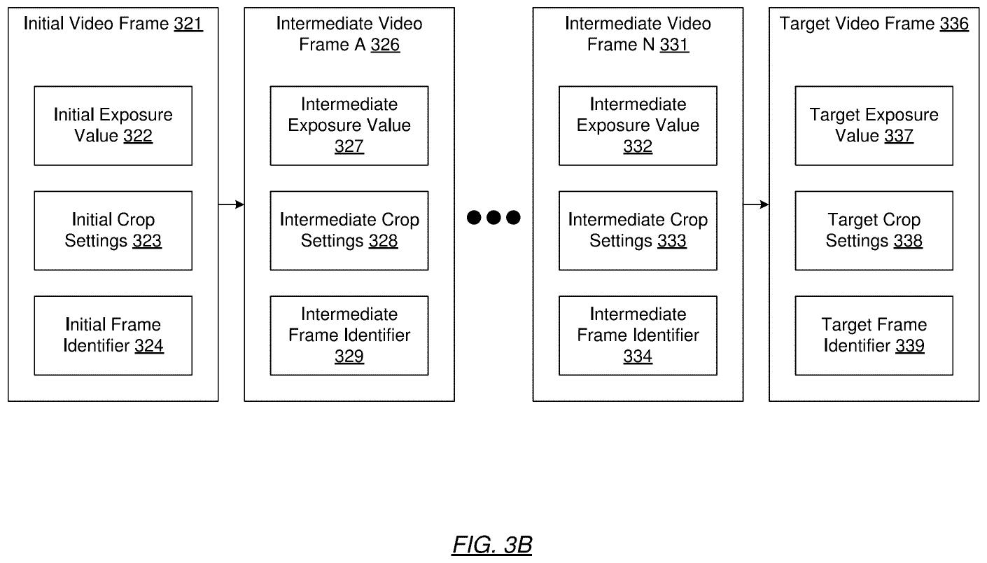

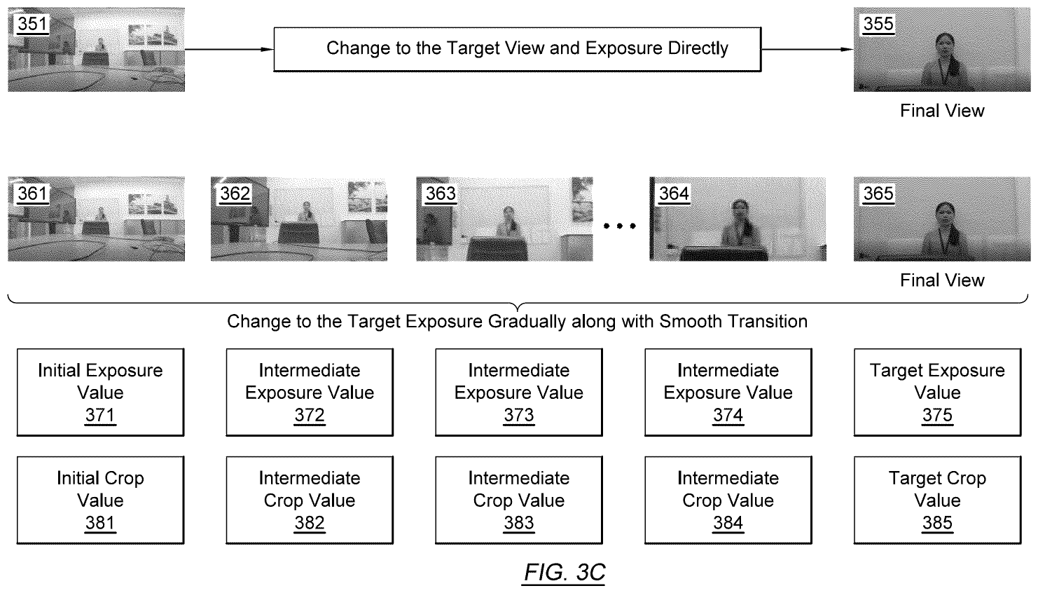

The camera (46) captures video and provides the captured video to the video module (40) and codec (42) for processing to generate the near-end video. For each video frame (e.g., initial video frame (301) of FIG. 3A) of near-end video captured by the camera (46), the control module (20) or the video module (40) may crop the video frame to the view region based on a selected view. In general, a video frame (also referred to as a frame) is a single still image in a video feed or video stream, that together with the other video frames form the video stream sent between endpoints. The view region may be selected based on the near-end audio generated by the microphone (120) and the additional microphones (121), other sensor data, or a combination thereof. For example, the control module (20) may select an area of the video frame depicting a participant who is currently speaking as the view region. As another example, the control module (20) may select the entire video frame as the view region in response to determining that no one has spoken for a period of time. Thus, the control module (20) selects view regions based on the context of a communication session.

The camera (46) uses an exposure value to identify the length of time an image will be exposed to the image sensor to generate the raw image data for a video frame. The video module (40) includes the exposure logic (72) that identifies an exposure value for video frames based on raw image data. As an example, matrix metering may be used to determine the exposure value. Matrix metering works by dividing a frame into sixteen “zones”, which are analyzed on an individual basis for light intensity. In a room view, the camera (46) averages the results of all zones to get the final camera exposure. When a target view is identified, an image processor of the camera (46) recalculates the exposure value for the zones and adjusts the weights of the zones so that the zones that are coincident with the target view are weighted higher than the other zones to generate the exposure value for the current view. The weight of a particular zone may be proportional to amount of overlap between the area defined by the coordinates of the target view and the area defined by the coordinates of the zone. In some embodiments, the control module (20), the video module (40), and the camera (46) operate in concert so that a transition from a current view to a target view will generate the video frame of the target view (the target video frame) using the target exposure value calculated for the target view, instead of with the exposure value of an initial view.

An exposure value may be a correct exposure value when an exposure value within a threshold percentage (e.g., 1%) of an exposure value determined using an exposure calculation algorithm. The matrix metering algorithm discussed above may be used to determine exposure values and identify whether an exposure value is correct. Different exposure algorithms may be used.

The endpoint (10) uses the codecs (32, 42) to encode the near-end audio and the corrected near-end video according to an encoding standard, such as MPEG-1, MPEG-2, MPEG-4, H.261, H.263, H.264, etc. Then, the network module (50) outputs the encoded near-end audio and corrected video to the remote endpoints (60) via the network (55) using an appropriate protocol. Similarly, the network module (50) receives the far-end audio and video via the network (55) from the remote endpoints (60) and sends these to their respective codecs (32, 42) for processing. Eventually, a loudspeaker (130) outputs the far-end audio (received from a remote endpoint), and a display (48) outputs the far-end video. The display (48) also outputs the corrected near-end video in some embodiments.

Thus, FIG. 1A illustrates an example of an improved device that adjusts exposure values used to capture video by the camera (46). In particular, the device of FIG. 1A may operate according to one of the methods described further below with reference to the other figures of the application. As described below, these methods may improve video quality during a communication session.

FIG. 1B illustrates components of the conferencing endpoint of FIG. 1A with additional detail. The endpoint (10) includes the processing unit (110), the memory (140), the network interface (150), and the general input/output (I/O) interface (160) coupled via the bus (100). As above, the endpoint (10) has the base microphone (120), the loudspeaker (130), the camera (46), and the display (48).

The processing unit (110) may include multiple processors, including a CPU, a GPU, an application processor, etc. The memory (140) may be any conventional memory such as SDRAM and can store modules (145) in the form of software and firmware for controlling the endpoint (10). The stored modules (145) include the various video and audio codecs (32, 42) and software components of the other modules (20, 30, 40, 50) discussed previously. Moreover, the modules (145) can include operating systems, a graphical user interface (GUI) that enables users to control the endpoint (10), and other algorithms for processing audio/video signals.

The network interface (150) provides communications between the endpoint (10) and remote endpoints (60). By contrast, the general I/O interface (160) can provide data transmission with local devices such as a keyboard, mouse, printer, overhead projector, display, external loudspeakers, additional cameras, microphones, etc.

As described above, the endpoint (10) captures video frames of video for a video stream using an exposure value and crops the video frames to a view. Thus, FIG. 1B illustrates an example of a physical configuration of a device that enhances video quality by transitioning to a target view using a target exposure value instead of using an initial exposure value.

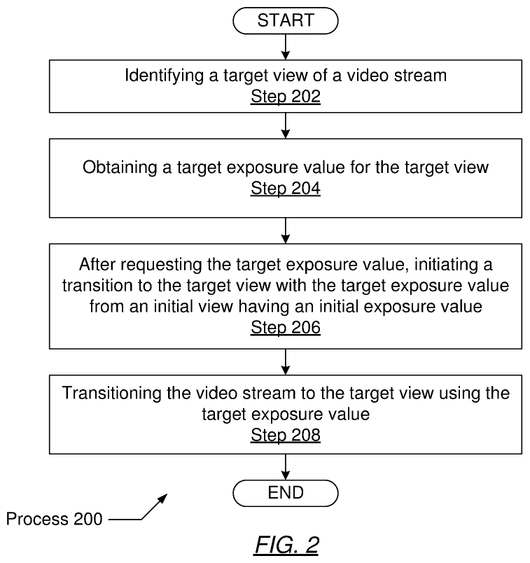

FIG. 2 shows a flowchart of a method in accordance with one or more embodiments of the disclosure. The process (200) transitions to a target view using a target exposure value. While the various steps in the flowcharts are presented and described sequentially, one of ordinary skill will appreciate that at least some of the steps may be executed in different orders, may be combined or omitted, and at least some of the steps may be executed in parallel. Furthermore, the steps may be performed actively or passively. For example, some steps may be performed using polling or be interrupt driven in accordance with one or more embodiments. By way of an example, determination steps may not have a processor process an instruction unless an interrupt is received to signify that condition exists in accordance with one or more embodiments. As another example, determinations may be performed by performing a test, such as checking a data value to test whether the value is consistent with the tested condition in accordance with one or more embodiments.

Turning to FIG. 2, in Step 202, a target view of a video stream is identified. The target view is a rectangular area of a raw video image from a camera. The target view may be a room view, a speaker view, a group view, or a conversation view. The target view may be identified by an application processor executing facial recognition algorithms on the video data from the camera and sound location algorithms on the audio data from the microphone.

In Step 204, a target exposure value is obtained for the target view. The target exposure value may be obtained by the application processor or the image processor in response to the application processor requesting the target exposure value from the image processor. The target exposure value may be requested prior to transitioning to the target view without waiting for auto exposure to determine the target exposure value during or after transitioning to the target view. The exposure values during and after a transition may be precalculated and then used, as discussed below, during and after a transition so that high quality images with the correct exposure value are generated during and after a transition. The request may be performed with a call to an application programming interface of the image processor by the application processor. After calculating the target exposure value, the image sensor may store the target exposure value and may also provide a return value to the application processor that includes the target exposure value along with the frame identifier that corresponds to the video frame in the video stream for which the exposure value will be applied by the camera.

In Step 206, after obtaining the target exposure value, a transition is initiated to the target view with the target exposure value from an initial view having an initial exposure value. The transition is initiated after obtaining the target exposure value instead of being initiated before the target exposure value has been obtained so that the target view may be displayed using the pre-calculated target exposure value instead of showing the target view using the initial exposure value and then updating the exposure value. The target exposure value for a conversation view may be the average of the exposure values for the individual speaker views that make up the conversation view.

In Step 208, the video stream transitions to the target view using the target exposure value. The transition is made after obtaining the target exposure value so that the target view will be displayed with the pre-calculated target exposure value instead of showing the target view using the initial exposure value.

The transition to the target view may be made using a direct cut using a single video frame of the video stream. With a direct cut, the initial video frame and target video frame are juxtaposed in the video stream with the initial video frame using the initial exposure value and the target video frame using the target exposure value.

The transition to the target view may also use an indirect cut using multiple video frames. The multiple video frames may include an initial frame, multiple intermediate frames, and the target frame. The multiple intermediate frames may have corresponding intermediate exposure values that are between the initial exposure value for the initial frame and the target exposure value for the target frame for the video stream.

The intermediate exposure values may transition linearly from the initial exposure value to the target exposure value for the video stream. The transition may also include a smooth linear transition of crop settings for camera panning, tilting, and zooming of the video frame to arrive at the target video frame for the target view. The crop settings identify a rectangle within an uncropped video frame (e.g., a raw video frame from the camera) that forms the target video frame. The crop settings include coordinates that may identify at least one corner of the rectangle and may identify the height and width of the rectangle. The initial crop settings and initial exposure values step gradually through a sequence of intermediate crop settings and intermediate exposure values to arrive at the target crop settings and target exposure value. The intermediate exposure values (and crop settings) may be calculated using the equation below.

$$E {V}_{t} = E {V}_{P} + \frac{( E {V}_{T} - E {V}_{P} ) * t}{T} , t ∈ [ 0 , T ] \qquad ( Eq . 1 )$$

In the equation above, EVₚ is the initial exposure value, EV_{T} is the target exposure value, EVₜ is the intermediate exposure value of the video frame identified with the number t, T is the number of frames used to transition from the initial exposure value to the target exposure value and corresponds to the target video frame. When t=T, the smooth transition is done and Equation 2 applies.

$${EV}_{t} = {EV}_{T} \qquad ( Eq . 2 )$$

After the transition, the image processor reverts back to using auto exposure (AE). Auto exposure calculates the exposure value to use for the next video frame from an exposure calculation using the current video frame.

The transition may be initiated after a set of criteria are satisfied. The criteria may include satisfaction of a continuous speech threshold, the state of a view lock, the satisfaction of a speaker location stability threshold, etc. The transition may be initiated after one or multiple criteria are satisfied.

The continuous speech threshold may identify a length of time (e.g., 2 seconds of continuous speech) for a speaker to continuously speak before the target view transitions to a speaker view for the speaker. The location of the speaker within a video frame may be identified and tracked with the facial recognition algorithms and the speech location algorithms discussed above to identify that it is a single speaker satisfying the continuous speech threshold.

The view lock may be a user configuration setting of an endpoint that identifies whether the endpoint is “locked” into the current view so that the view will not change. When the view lock is disabled, the criteria is satisfied and the transition may be initiated.

The speaker location stability threshold may identify a distance within the video frame (e.g., 50 pixels) within which the location of a speaker is to remain in order for the transition to initiate. As an example, if the speaker moves beyond the speaker location stability threshold while speaking, the endpoint may remain in a room view instead of switching to a speaker view.

In one embodiment, the application processor may crop the target video frame. The application processor receives, from the image processor, a frame identifier that identifies the target video frame. The application processor then receives the target video frame from an imaging component (e.g., the camera). The received target video frame corresponds to the frame identifier received by the application processor from the image processor. The application processor crops the target video frame using the crop settings for the target view to form a cropped target video frame. After cropping, the endpoint displays the cropped target video frame.

In one embodiment, the image processor may crop the target video frame. By cropping the target video frame with the image processor, the image processor may return a response code to the application processor that does not include a frame identifier for the target frame in response to a request from the application processor to pre-calculate the target exposure value. The image processor crops the target video frame, forming a cropped target video frame, which may be displayed by the endpoint.

FIG. 3A, FIG. 3B, and FIG. 3C show examples of systems in accordance with the disclosure. FIG. 3A shows an example of a direct cut. FIG. 3B shows an example of an indirect cut. FIG. 3C shows an example a direct cut and an indirect cut. The embodiments of FIG. 3A, FIG. 3B, and FIG. 3C may be combined and may include or be included within the features and embodiments described in the other figures of the application. The features and elements of FIG. 3A, FIG. 3B, and FIG. 3C are, individually and as a combination, improvements to the technology of video conferencing systems and imaging systems. The various features, elements, widgets, components, and interfaces shown in FIG. 3A, FIG. 3B, and FIG. 3C may be omitted, repeated, combined, and/or altered as shown.

Accordingly, the scope of the present disclosure should not be considered limited to the specific arrangements shown in FIG. 3A, FIG. 3B, and FIG. 3C.

Turning to FIG. 3A, a direct cut from the initial video frame (301) to the target video frame (308) does not include any intermediate frames. The initial exposure value (302) and initial crop settings (303) transition directly to the target exposure value (309) and the target crop settings (310). The initial frame identifier (304) may be one less than the target frame identifier (311), e.g., the initial frame identifier (304) may be identified as frame number “0” and the target frame identifier (311) may be identified as frame number “1”.

Turning to FIG. 3B, an indirect cut includes the initial video frame (321), through a set of intermediate video frames (the intermediate video frame A (326) through the intermediate video frame N (331)), to the target video frame (336). The intermediate video frames (326, 331) include intermediate exposure values (327, 332), crop settings (328, 333), and frame identifiers (329, 334) that are between the initial exposure value (322), the initial crop settings (323) and the initial frame identifier (324) of the initial video frame (321) and the target exposure value (337), the target crop settings (338), and the target frame identifier (339) of the target video frame (336).

Turning to FIG. 3C, an endpoint may use either a direct cut or a smooth cut to transition between a room view and a speaker view. The initial video frame (351) and the target video frame (355) show a direct cut. The initial video frame (361), the intermediate video frames (362, 363, 364), and the target frame (365) illustrate a smooth transition (an indirect cut).

The initial video frames (351, 361) include the same initial exposure value (371) and the same initial crop settings (381). The target video frames (355, 365) include the same target exposure value (375) and the same target crop settings (385).

The intermediate video frames (362, 363, 364) include the intermediate exposure values (372, 373, 374) and the intermediate crop settings (382, 383, 384). The intermediate exposure values (372, 373, 374) are between the initial exposure value (371) and the target exposure value (375) and may form a linear transition. The intermediate crop settings (382, 383, 384) may also form a linear transition between the initial crop settings (381) and the target crop settings (385).

TABLE 1

| | | Exposure | |
|---|---|---|---|
| | Frame | Value | |
| | Identifier | (seconds) | Crop Settings (pixels) |
| Initial frame | 0 | 0.0200 | (1, 1, 3840, 2160) |
| Intermediate frame | 1 | 0.0175 | (25, 50, 3005, 1726) |
| Intermediate frame | 2 | 0.0150 | (50, 100, 2170, 1292) |
| Intermediate frame | 3 | 0.0125 | (75, 150, 1335, 858) |
| Target frame | 4 | 0.0100 | (100, 200, 500, 425) |

The table above includes an example of frame identifiers, crop settings, and exposure values for an indirect cut (also referred to as a smooth transition). The frame identifiers are integer values numbered consecutively relative to the initial frame. The crop settings include two pairs of pixel values identifying a rectangle by the top left corner and the bottom right corner of the rectangle relative to the raw video frame from the camera. The exposure value is a floating point value that identifies the number of seconds of exposure for the video frame. Different types and formats may be used to convey similar information. For example, the crop settings may identify the rectangle by the location of the top left corner with a length and width of the rectangle (instead with the location of the bottom right corner). As another example, the exposure value may be an integer value that, when divided by a constant (e.g., 10,000), identifies the duration of the exposure.

The above description of functions presents only a few examples of functions performed by the disclosed systems. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure. Accordingly, the scope of the disclosure should be limited only by the attached claims.

What is claimed is:

1. A method comprising:
identifying a target view of a video stream;
obtaining a target exposure value for the target view;
after obtaining the target exposure value, initiating a transition to the target view with the target exposure value from an initial view having an initial exposure value; and
transitioning the video stream to the target view using the target exposure value.

2. The method of claim 1, further comprising:
transitioning to the target view using a direct cut using a single video frame of the video stream.

3. The method of claim 1, further comprising:
transitioning to the target view using an indirect cut using a plurality of video frames, the plurality of video frames having a plurality of intermediate exposure values between an initial exposure value and the target exposure value for the video stream.

4. The method of claim 3, wherein the plurality of intermediate exposure values transition linearly from an initial exposure value to the target exposure value for the video stream.

5. The method of claim 1, further comprising:
requesting, by an application processor, the target exposure value from an image processor.

6. The method of claim 1, further comprising:
initiating the transition after requesting the target exposure value and after a continuous speech threshold is satisfied.

7. The method of claim 1, further comprising:
initiating the transition after requesting the target exposure value and after a view lock is disabled.

8. The method of claim 1, further comprising:
initiating the transition after requesting the target exposure value and when a speaker location stability threshold is satisfied.

9. The method of claim 1, further comprising:
receiving, by an application processor from an image processor, a frame identifier that identifies a target video frame;
receiving, by the application processor, the target video frame from an imaging component comprising the image processor;
cropping, by the application processor, the target video frame using the target view to form a cropped target video frame; and
displaying the cropped target video frame.

10. A system comprising:
an application processor;
a memory;
an image processor;
the memory comprising an application, wherein the application executes on the application processor, uses the memory, and is configured for:
identifying a target view of a video stream;
obtaining, by the application processor from the image processor, a target exposure value for the target view;
after obtaining the target exposure value, initiating a transition to the target view with the target exposure value from an initial view having an initial exposure value; and
transitioning the video stream to the target view using the target exposure value.

11. The system of claim 10, wherein the application is further configured for:
transitioning to the target view using a direct cut using a single video frame of the video stream.

12. The system of claim 10, wherein the application is further configured for:
transitioning to the target view using an indirect cut using a plurality of video frames, the plurality of video frames having a plurality of intermediate exposure values between an initial exposure value and the target exposure value for the video stream.

13. The system of claim 12, wherein the plurality of intermediate exposure values transition linearly from an initial exposure value to the target exposure value for the video stream.

14. The system of claim 10, wherein the application is further configured for:
initiating the transition after requesting the target exposure value and after a continuous speech threshold is satisfied.

15. The system of claim 10, wherein the application is further configured for:
initiating the transition after requesting the target exposure value and after a view lock is disabled.

16. The system of claim 10, wherein the application is further configured for:
initiating the transition after requesting the target exposure value and when a speaker location stability threshold is satisfied.

17. The system of claim 10, wherein the application is further configured for:
receiving, by the application processor from the image processor, a frame identifier that identifies a target video frame;
receiving, by the application processor, the target video frame from an imaging component comprising the image processor;
cropping, by the application processor, the target video frame using the target view to form a cropped target video frame; and
displaying the cropped target video frame.

18. The system of claim 10, wherein the application is further configured for:
cropping, by the image processor, a target video frame using the target view to form a cropped target video frame; and
displaying the cropped target video frame.

19. A set of one or more non-transitory computer readable mediums comprising computer readable program code for:
identifying a target view of a video stream;
obtaining a target exposure value for the target view;
after obtaining the target exposure value, initiating a transition to the target view with the target exposure value from an initial view having an initial exposure value; and
transitioning the video stream to the target view using the target exposure value.

20. The set of one or more non-transitory computer readable mediums of claim 19, further comprising computer readable program code for:
transitioning to the target view using a direct cut using a single video frame of the video stream.
